(19) United States
(12) Patent Application Publication
(10) Pub. No.: US 2026/0081669 A1
(43) Pub. Date: Mar. 19, 2026

(54) TECHNIQUES FOR MANAGING ANTENNA PANEL PERFORMANCE DEGRADATION

(71) Applicant: QUALCOMM Incorporated, San Diego, CA (US)

(72) Inventors: Vasanthan RAGHAVAN, West Windsor Township, NJ (US); Junyi LI, Greentown, PA (US); Jung Ho RYU, Fort Lee, NJ (US); Juergen CEZANNE, Ocean Township, NJ (US)

(21) Appl. No.: 18/889,793

(22) Filed: Sep. 19, 2024

(51) Int. Cl. H04B 7/06; H04B 7/0456; H04B 17/318; H04W 48/16

(52) U.S. Cl. CPC H04B 7/0632; H04B 7/0486; H04B 7/0608; H04B 17/328; H04W 48/16

(57) ABSTRACT

Certain aspects of the present disclosure provide techniques for wireless communication by a user equipment (UE). An example method includes communicating with a wireless node using one or more antenna panels, detecting a persistent drop in signal quality associated with at least one antenna panel of the one or more antenna panels based on the communication, and transmitting, to the wireless node, information including an indication of the persistent drop in signal quality associated with the at least one antenna panel.

### BACKGROUND

### Field of the Disclosure

Aspects of the present disclosure relate to wireless communications, and more particularly, to techniques for managing antenna panel or antenna module performance degradation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes communicating with a wireless node using one or more antenna panels; detecting a persistent drop in signal quality associated with at least one antenna panel of the one or more antenna panels based on the communication; and transmitting, to the wireless node, information including an indication of the persistent drop in signal quality associated with the at least one antenna panel.

Another aspect provides a method for wireless communication by a wireless node. The method includes communicating with a user equipment (UE); receiving, from the UE, information including an indication of a persistent drop in signal quality associated with at least one antenna panel of the UE; and taking one or more actions based on the indication of the persistent drop in signal quality associated with the at least one antenna panel of the UE.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a process flow including operations for communications in a network between a wireless node and a user equipment.

FIG. 6 depicts a method for wireless communications.

FIG. 7 depicts a method for wireless communications.

FIG. 8 depicts aspects of an example communications device.

FIG. 9 depicts aspects of an example communications device.

### DETAILED DESCRIPTION

Aspects of the present disclosure provide apparatuses, methods, processing systems, and computer-readable mediums for managing antenna panel or antenna module performance degradation.

For example, a user equipment (UE) may communicate using one or more antenna panels with beamforming, which are designed to improve signal strength or link margin given harsher propagation losses at higher carrier frequencies. However, in some cases, these antenna panels may become damaged due to mechanical or other failures, which may cause them to malfunction or fail. For example, damage may occur during manufacturing or assembly of the UE due to angled or offset insertion of these antenna panels or by excessive force applied to these antenna panels. Additionally, in some cases, the issues experienced during manufacturing or assembly may also lead to repeated bending of these antenna panels during normal use of the UE, especially in foldable UEs, which may lead to failure or malfunction. For example, in some cases, repeated bending of these antenna panels may lead to a partial or total failure of connections between antenna elements of the one or more antenna panels and a radio frequency integrated circuit (RFIC) chip.

In some cases, the malfunction or failure of an antenna panel may result in a persistent drop in signal quality associated with this antenna panel. When such failures occur, a base station may misinterpret the persistent drop in signal quality as a temporary issue, adjusting communication parameters to compensate for the drop in signal quality. This misinterpretation may lead to inefficient/high overhead “ping-pong” adjustments in network settings, increasing signaling overhead between the base station and the UE and negatively impacting performance.

Accordingly, aspects of the present disclosure provide techniques that may be used to detect a persistent drop in signal quality associated with at least one antenna panel of a UE and to transmit information to a network entity, such as a BS, that includes an indication of the persistent drop in signal quality associated with the at least one antenna panel of the UE. In some cases, the indication of the persistent drop in signal quality may allow the network entity to take one or more actions to mitigate or reduce the effects of the antenna panel failure and associated persistent drop in signal quality.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

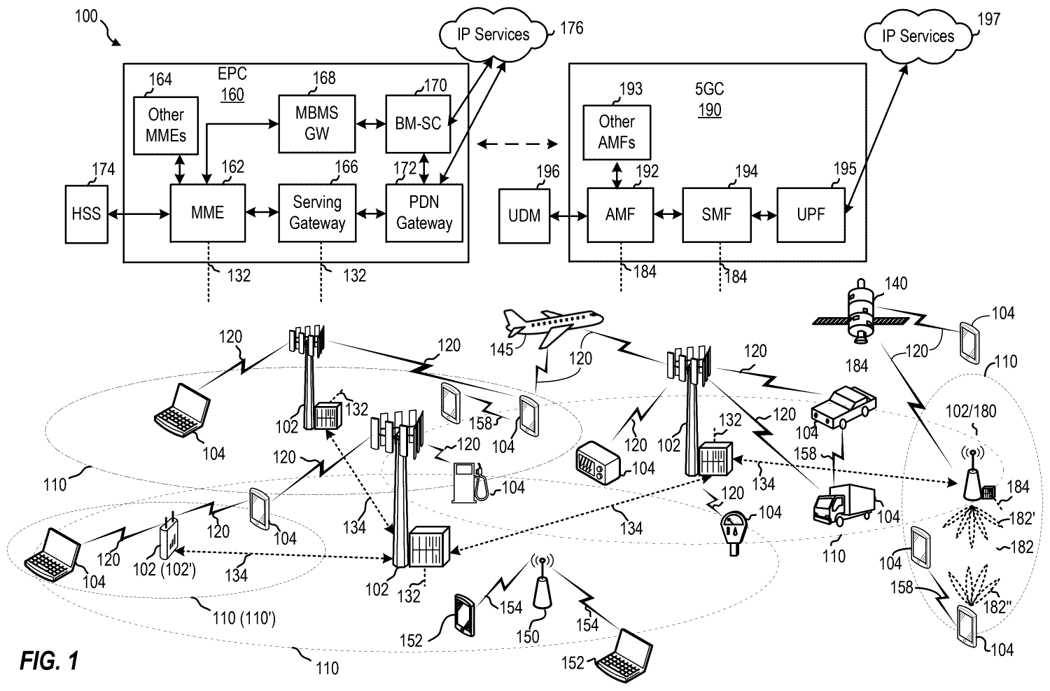

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

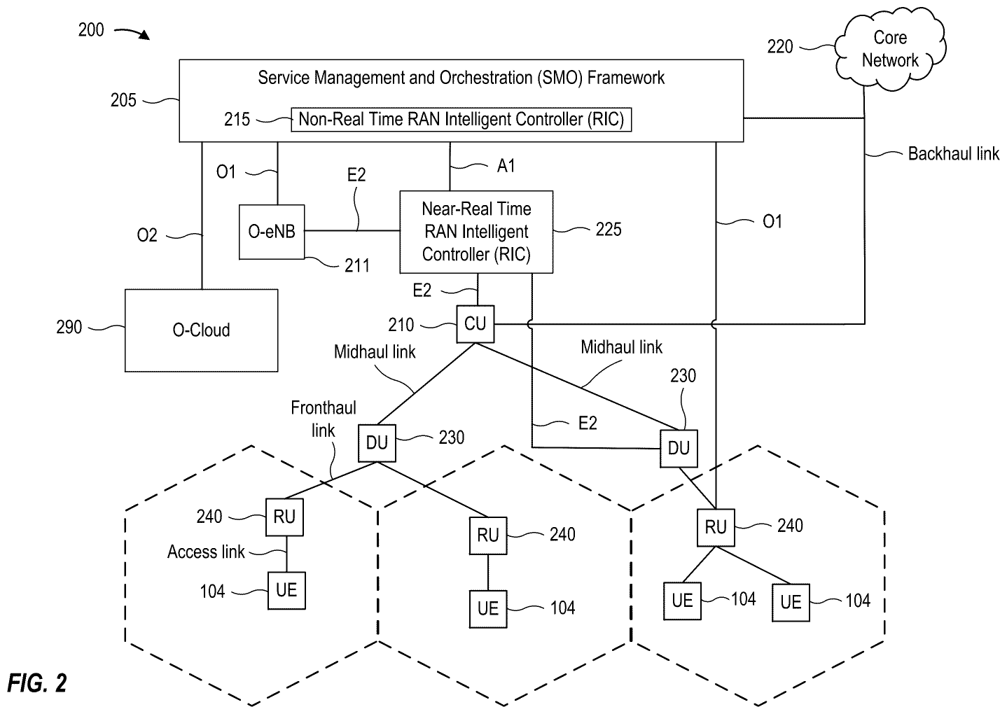

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

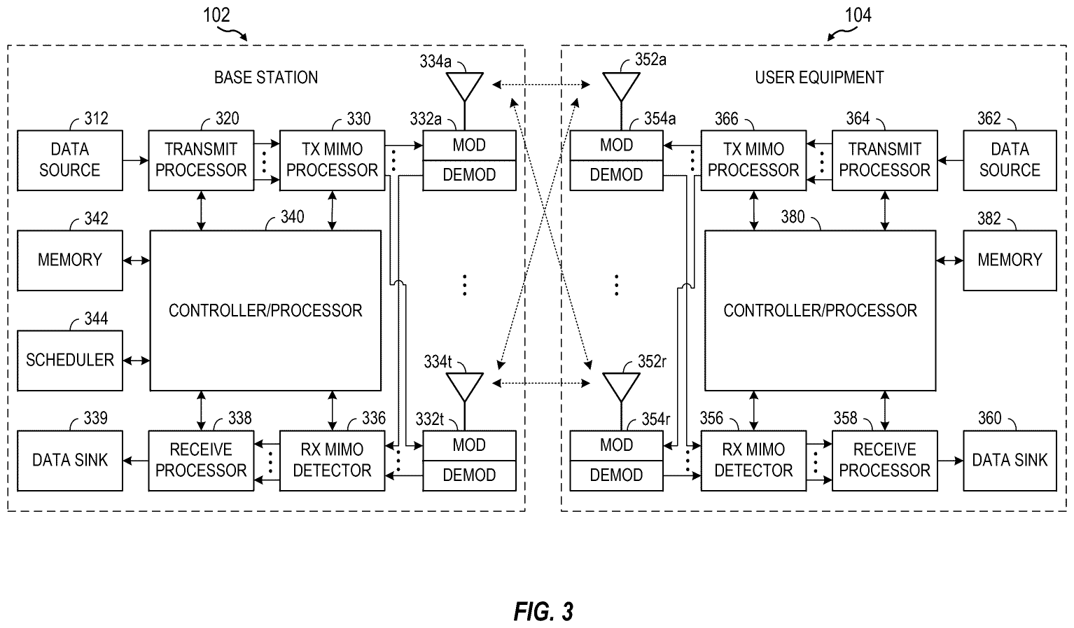

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

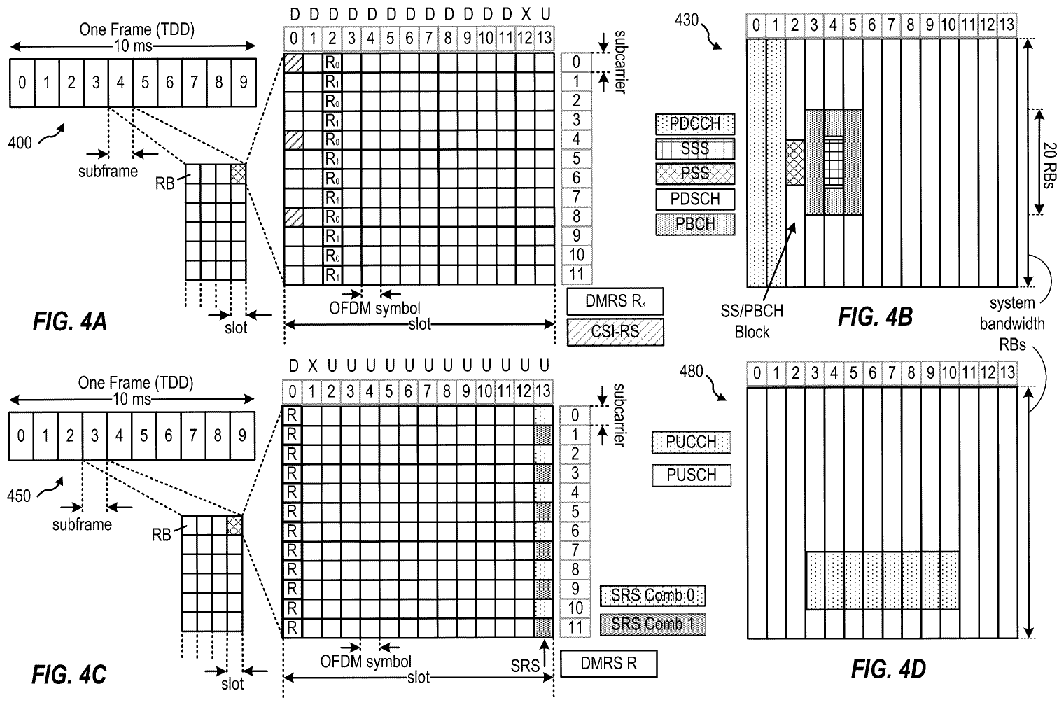

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Multi-Antenna Panel Communication

In certain systems, such as the wireless communication network 100 of FIG. 1, UEs and BSs may be able to transmit or receive transmissions using multiple antennas, beams, and/or antenna panels (e.g., antenna element arrays). An antenna panel may comprise a collection of transceiver units (TXRUs) that are connected to a set of antenna elements, each of which is equipped with a phase shifter and/or amplitude control capabilities. Thus, the antenna elements controlled by a TXRU are capable of generating a coherent transmission with a set of beam weights performed at the radio frequency (RF) or analog level. In some cases, when a dual-polarized array is used, the one beam may correspond to two antenna ports. In some cases, same sets or different sets of antenna panels can be used for DL reception and UL transmission. For example, in some cases, the same set of antenna panels may be used for both DL reception and UL transmission while in other cases different sets of antenna panels could be used for DL reception as compared to UL transmission.

Additionally, antenna panels can be associated with the same as well as different numbers of antenna ports, a number of beams, and/or an effective isotropic radiated power (EIRP). In some cases, while different antenna panels may share a same number of beams, there may not be beam correspondence across different antenna panels. Further, in some cases, each antenna panel may be associated with the same or independent operation parameters, such as power control (PC) parameters, a fast Fourier transform timing window, a timing advance (TA) parameter, and the like. Additionally, each antenna panel of the UE may be associated with a particular panel identifier (ID) or an antenna panel group ID. In some cases, the antenna panel ID or antenna panel group ID may include one or more of a beam group ID, a transmission configuration indicator (TCI) state pool ID, a sounding reference signal (SRS) resource group ID, a control resource set (CORESET) pool ID, or a closed loop power control index.

In some cases, the capability to perform transmissions using multiple panels may be especially useful for higher frequency transmission, such as millimeter wave transmissions described above. In some cases, the transmissions associated with a UE may be received from or transmitted to a serving BS or transmission reception point (TRP) via a Uu interface. Generally, transmissions using multiple antenna panels may allow for increased throughput (e.g., by simultaneously or concurrently transmitting/receiving data to/from the BS using the multiple antenna panels) and/or increased reliability (e.g., by sending/receiving the same information using the multiple antenna panels). Such transmissions may be referred to as multi-panel transmissions.

### Aspects Related to Techniques for Managing Antenna Panel Performance Degradation

As noted above, user equipments (UEs) may communicate using one or more antenna panels. These antenna panels, or modules, are commonly deployed in Frequency Range 2 (FR2), and may also be employed in Frequency Range 3 (FR3). In some scenarios, such as in customer premises equipment (CPE), multiple antenna panels may be tiled together to enhance signal performance and provide wider coverage.

In general, each antenna panel is expected to perform flawlessly over time, with no anticipated degradation in signal quality. However, in reality, antenna panels may experience a drop in signal performance or quality over time. This drop in signal performance or quality may be due to several reasons. For example, in modern wireless devices, UEs are no longer manufactured using a single, unified semiconductor manufacturing process. Instead, different components of the UE are built through distinct manufacturing processes at different nodes. For example, antenna panels may be manufactured through one process, while routing and IC flip-chip transitions may be produced through another. These separately manufactured components must then be assembled together. During assembly, issues such as angled or offset insertion of the antenna panels, or the application of excessive force, may arise, potentially damaging the panels. In some cases, angled or offset insertion, combined with excessive force during assembly, may cause the antenna panels to become repeatedly bent during normal use of the UE, further increasing the likelihood of damage. This is particularly relevant in certain UEs that support folding or flipping functionality, where repeated bending and stress on the antenna panels can lead to additional damage. Additionally, integrated chip (IC) connections between the antenna panels and one or more low-noise amplifiers (LNAs) or power amplifiers (PAs) may break due to repeated bending or excessive force, resulting in a reduction in downlink (DL) and uplink (UL) performance, respectively.

In some cases, damage to an antenna panel may lead to partial failure of the antenna panel or total failure of the antenna panel. A partial failure may involve a subset of antenna elements or circuits of the antenna panel losing connectivity, leading to a reduced beamforming array gain from the antenna panel (e.g., reduced by a threshold number of decibels (dB)). Further, failure of a subset of antenna elements may reduce the number of beams of a codebook that may be used/useful with the antenna panel. For example, in some cases, when a subset of antenna elements of an antenna panel fails, the antenna panel may only be left with a subset of beams, from a set of possible beams in the codebook, that are viable for communication. In some cases, the subset that is viable for downlink reception may be different from the subset that is viable for uplink transmission.

Total failure of an antenna panel may involve a scenario in which all antenna elements of an antenna panel lose connectivity, leading to only noise being received with this antenna panel. Moreover, in this case, because the antenna panel has failed completely, there may be no beams from the set of beams of the codebook that are viable for communication.

The partial or total failure of an antenna panel is typically persistent and cannot be resolved without replacing the antenna panel. As a result, the partial failure or total failure of an antenna panel may lead to a persistent drop in signal quality associated with that antenna panel. However, a network or base station (BS) may interpret this drop in signal quality as a semi-persistent failure, assuming the signal quality will return to normal once the event causing the issue (e.g., as seen in the case of a temporary blockage) is resolved. To handle what it perceives as a temporary issue, the BS may temporarily adjust communication parameters, such as the modulation and coding scheme (MCS), rank indicator (RI), channel quality indicator (CQI), etc., to mitigate the drop in signal quality. Once the “temporary” blockage is assumed to be cleared, the BS may revert back to a higher MCS, supported by the antenna panel of the UE. However, because the failure and drop in signal quality of the antenna panel, this can result in a “ping pong” effect, where the BS continuously switches between MCS settings, leading to increased signaling overhead and reduced efficiency in network operations.

In some cases, when a failure or malfunction of an antenna panel of a UE occurs, it may be beneficial to notify the BS regarding a persistent drop in signal quality associated with this antenna panel failure, for example, to avoid the increase in signaling overhead discussed above. However, in current wireless communications systems, the UE may not have a way to indicate such information to the BS.

Accordingly, aspects of the present disclosure provide techniques that may be used to detect a persistent drop in signal quality associated with at least one antenna panel of a UE and to transmit information to a network entity, such as a BS, that includes an indication of the persistent drop in signal quality associated with the at least one antenna panel of the UE. In some cases, the indication of the persistent drop in signal quality may allow the network entity to take one or more actions to mitigate or reduce the effects of the antenna panel failure and associated persistent drop in signal quality. For example, in some cases, the network entity may take one or more actions related to beam management, such as canceling (e.g., not using) or deprioritizing certain beams associated with the at least one panel. In some cases, the network entity may take actions such as to change one or more communication parameters (e.g., MCS, RI, CQI), deactivate certain transmission configuration indicator (TCI) states associated with the at least one antenna panel, increase a number of antennas that the network entity uses to communicate with the UE, and other actions as described herein.

### Example Operations of Entities in a Communications Network

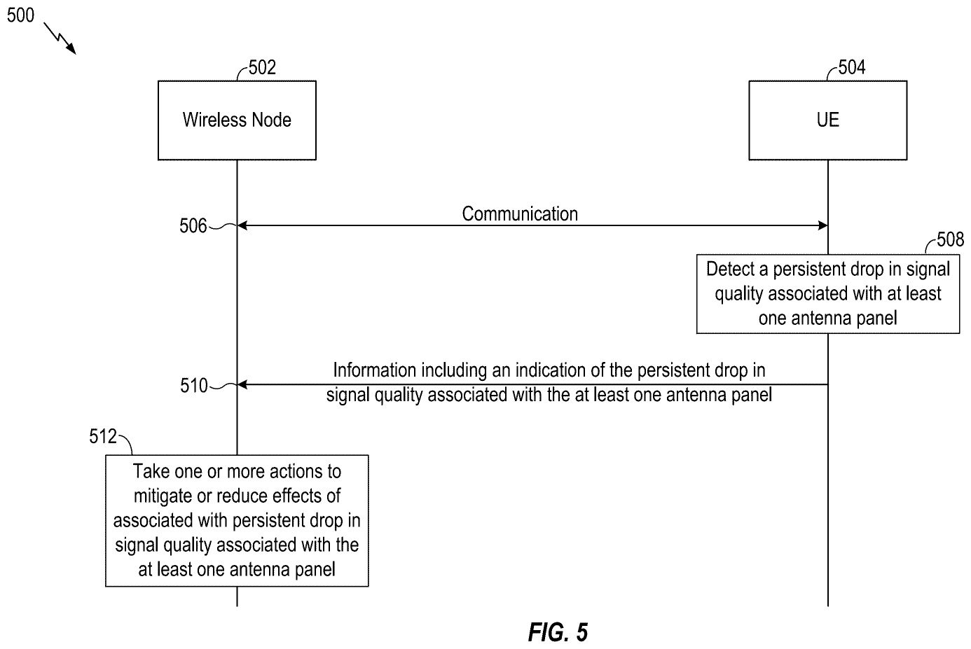

FIG. 5 depicts a process flow including operations 500 for communications in a network between a wireless node 502 and a user equipment (UE) 504. In some cases, operations 500 may include operations for managing antenna panel performance degradation at the UE 504. In some cases, operations 500 may be applicable to various frequency ranges, such as FR2 and FR3, as well as other frequency ranges. In some aspects, the UE 504 may be an example of UE 104 depicted and described with respect to FIGS. 1 and 3. In some aspects, the wireless node 502 may be an example of the BS 102 depicted and described with respect to FIGS. 1 and 3 or a disaggregated base station depicted and described with respect to FIG. 2. In some cases, the wireless node 502 may be another UE, such as another example of UE 104 depicted and described with respect to FIGS. 1 and 3.

Operations 500 begin at 506 with the UE 504 communicating with the wireless node 502 using one or more antenna panels or modules. In some cases, when the wireless node 502 comprises a base station, communicating may include receiving downlink signaling from the wireless node 502 and transmitting uplink signaling to the wireless node. In some cases, when the wireless node 502 comprises another UE, communicating may include sidelink communication, such as receiving sidelink signals from the wireless node 502 and transmitting sidelink signals to the wireless node 502.

At 508, the UE 504 may detect a persistent drop in signal quality associated with at least one antenna panel/module of the one or more antenna panels/modules based on the communication. In some cases, the persistent drop in signal quality may be based on a failure of the at least one antenna panel, such as a total failure of all antenna elements or circuits of the at least one antenna panel or a partial failure of a subset of antenna elements or circuits. In some cases, the UE 504 may detect the failure of the at least one antenna panel and associated using a directional coupler. For example, in some cases, the UE 504 may be equipped with a directional coupler, which is an RF circuit element that senses the amount of power that is fed into the at least one antenna panel. More specifically, for example, in some cases, if the UE 504 detects (e.g., via the directional coupler) more power than normal is being reflected back from the at least one antenna panel during the communication with the wireless node 502, this may be an indication that the at least one antenna panel has failed (e.g., totally or partially) and that there is a persistent drop in signal quality associated with the at least one antenna panel.

At 510, the UE 504 transmits, to the wireless node 502, information including an indication of the persistent drop in signal quality associated with the at least one antenna panel.

In some cases, the indication of the persistent drop in signal quality comprises a persistent decrease in downlink reference signal received power (RSRP) associated with downlink reception using the at least one antenna panel. In some cases, the indication of the persistent drop in signal quality comprises a persistent decrease in equivalent isotropic radiated power (EIRP) associated with uplink transmission using the at least one antenna panel. In some cases, the UE 504 may transmit the information when the drop in the signal quality is greater than or equal to a threshold (e.g., threshold RSRP or threshold EIRP).

In some cases, the information may comprise capability information of the UE 504 and the UE 504 may dynamically include a field within the capability information that indicates the persistent drop in signal quality associated with the at least one antenna panel. In some cases, the indication of the persistent drop in signal quality associated with the at least one antenna panel may indicate how many of the antenna elements of the at least one panel are functioning or not functioning or may indicate how many antenna panels of the plurality of antenna panels of the UE 504 are functioning or not functioning.

In some cases, the information transmitted further includes an indication of a restriction related to a rank indicator (RI) for communication between the UE 504 and the wireless node 502 and/or a channel quality indicator (CQI) for communication between the UE 504 and the wireless node 502. In some cases, the restriction related to the RI and/or CQI may be helpful in scenarios in which the drop in signal quality associated with a failure of the at least one antenna module of the UE 504 is not symmetric between uplink and downlink communication. For example, there may be some scenarios in which a set of LNAs of the at least one antenna panel have failed, but not the associated PAs of the at least one antenna panel. In such scenarios, since the PAs of the at least one antenna panel are still functioning, the UE 504 may be able to send sounding reference signals (SRSs) over rank-2 to the wireless node 502. However, since the UE 504 has sent rank-2 SRS, the wireless node 502 may also attempt to send downlink transmissions, such as a physical downlink shared channel (PDSCH), to the UE 504 using rank-2. However, since the LNAs (e.g., used to receive the downlink transmission from the wireless node 502) of the at least one panel have failed, the UE 504 may only be able to support receiving rank-1 downlink transmissions from the wireless node 502. In other words, because the LNAs of the at least one antenna panel have failed, the UE 504 may not be able to receive the rank-2 downlink transmissions from the wireless node 502.

Accordingly, in some cases, to avoid these scenarios, the UE 504 may indicate to the wireless node 502 a restriction related to RI for communication between the UE 504 and the wireless node 502 and/or a CQI for communication between the UE 504 and the wireless node 502. In some cases, the indication of the restriction related to the RI comprises an indication of at least one subset of RIs supported by the UE 504 after the detected persistent drop in signal quality associated with the at least one antenna panel relative to a larger set of RIs supported by the UE prior to the detected persistent drop in signal quality associated with the at least one antenna panel. In other words, the UE 504 may indicate which RIs are still supported by the at least one antenna panel as the result of the failure of the at least one antenna panel and associated persistent drop in signal quality.

In some cases, the at least one subset of RIs comprises at least one of a first subset of RIs for downlink signaling or a second subset of RIs for uplink signaling. For example, in the scenario above, the UE 504 may indicate that the at least one antenna panel is capable of supporting up to rank-2 for uplink transmissions to the wireless node 502 while only supporting up to rank-1 for downlink transmissions from the wireless node 502.

In some cases, the indication of the restriction related to the CQI comprises an indication of at least one subset of CQIs supported by the UE after the detected persistent drop in signal quality associated with the at least one antenna panel relative to a larger set of CQIs supported by the UE prior to the detected persistent drop in signal quality associated with the at least one antenna panel. In some cases, the at least one subset of RIs comprises at least one of a first subset of CQIs for downlink signaling or a second subset of CQIs for uplink signaling.

At 512 in FIG. 5, the wireless node 502 may take one or more actions based on the indication of the persistent drop in signal quality associated with the at least one antenna panel of the UE 504. As noted above, the one or more actions taken by the wireless node 502 may include one or more actions to mitigate or reduce the effects of a failure of the at least one antenna panel and the associated persistent drop in signal quality of the at least one antenna panel. For example, in some cases, the one or more actions may include the wireless node 502 increasing a number of antennas for the communication with the UE 504. For example, in some cases, the wireless node 502 may include the number of antennas that the wireless node 502 uses to transmit downlink signaling to the UE 504 or may include the number of antennas that the wireless node 502 uses to receive uplink signaling from the UE 504. In some cases, increasing the number of antennas that the wireless node 502 uses for uplink/downlink signaling may allow the wireless node 502 to compensate for a reduction in link budget on the DL/UL associated with the failure of the at least one antenna panel of the UE 504 and the associated persistent drop in signal quality.

In some cases, the taking the one or more actions at the wireless node 502 may include reducing a RI or a CQI for communication with the UE 504. For example, in some cases, the wireless node 502 and UE 504 may communicate with each other at 506 in FIG. 5 based on a first RI and a first CQI. Thereafter, in some cases, based on the indication of the persistent drop in signal quality associated with the at least one antenna panel, the wireless node 502 may transmit configuration information to the UE 504 including an indication of at least one of a second RI that is lower than the first RI or a second CQI that is lower than the first CQI. In some cases, the second RI may be lower than an RI that the at least one antenna panel could support absent the failure and associated persistent drop in signal quality. Similarly, the second CQI may be lower than a CQI that the at least one antenna panel could support absent the failure and associated persistent drop in signal quality. In some cases, taking the one or more actions may also include reducing an MCS for communication between the UE 504 and wireless node 502.

In some cases, when a failure of the at least one antenna panel occurs, leading to the persistent drop in signal quality, one or more communication beams of the wireless node 502 that are associated with the at least one antenna panel of the UE 504 may no longer be viable for communication with the wireless node 502. In some cases, if these non-viable beams were to continue to be used after the persistent drop in signal quality is detected, this may lead to increased signaling overhead between the wireless node 502 and UE 504 as well as increased power consumption at each of the wireless node 502 and UE 504.

Accordingly, in some cases, when the persistent drop in the signal quality of the at least one antenna panel is detected, the UE 504 may be configured to determine which communication beams of the wireless node 502 should not be used for communicating with the UE 504. In some cases, the beams may include one or more transmit beams of the wireless node 502 or one or more receive beams of the wireless node 502. For example, the beams may include beams of the wireless node 502 that should not be used for transmitting signaling to the UE 504, such as CSI-RSs. Additionally, in some cases, these beams may include beams of the wireless node 502 that should not be used for receiving sounding reference signals (SRSs) from the UE 504.

In some cases, the UE 504 may determine the beams of the wireless node 502 based on beams of the at least one antenna panel of the UE 504 that have failed. For example, each beam of the at least one antenna panel may be paired with a particular beam of the wireless node 502. Accordingly, to determine the beams of the wireless node 502 to not use for communicating with the UE 504, the UE 504 may compare beam pair mappings of the failed beams of the at least one antenna panel with beam indices of the beams of the wireless node 502, such as synchronization signal block (SSB) indices or channel state information reference signal (CSI-RS) beam indices. In some cases, the UE 504 may store these mappings and beam indices in a measurement table or measurement history based on SSB and/or CSI-RS measurements.

Accordingly, in some cases, information transmitted by the UE 504 at 510 may further include an indication of one or more beams of the wireless node 502 to not use for communicating with the UE 504. In some cases, the persistent drop in signal quality associated with the at least one antenna panel may be based on a failure or a malfunction of the at least one antenna panel. In some cases, the indication of the one or more beams of the wireless node 502 to not use for communicating with the UE 504 may comprise an indication of an expected performance loss of the one or more beams due to the malfunction or failure of the at least one antenna panel.

In some cases, the indication of the one or more beams to not use for communicating with the UE 504 may allow the wireless node 502 to determine whether to use one or more other beams for communicating with the UE 504 or to continue to use the one or more beams (e.g., that were indicated by the UE 504 to not use) regardless of the expected performance loss. In some cases, this determination may be a function of channel environment or channel conditions between the wireless node 502 and UE 504.

For example, in some cases, taking the one or more actions comprises determining whether or not to use the one or more beams for communicating with the UE 504. In some cases, the determination may be based on channel conditions (e.g., signal to noise ratio (SNR), signal to interference plus noise (SINR), etc.) between the wireless node 502 and the UE 504. In some cases, determining whether or not to use the one or more beams for communicating with the UE 504 may include determining to use the one or more beams for communicating with the UE 504 regardless of the expected performance loss of the one or more beams, for example, when the channel conditions are below a threshold.

In some cases, determining whether or not to use the one or more beams for communicating with the UE 504 may include determining to not use the one or more beams for communicating with the UE 504, for example, when the channel conditions are greater than or equal to a threshold. In this case, the wireless node 502 may select, from a plurality of beams used for communicating with the UE 504, one or more other beams for communicating with the UE.

In some cases, the UE 504 and wireless node 502 may communicate with each other at 506 using one or more beam pairs associated with the one or more antenna panels of the UE 504. In some cases, the UE 504 may be configured to transmit, to the wireless node 502, an indication (e.g., a report) of one or more TCI states associated with the one or more beam pairs and RSRP measurements associated with the one or more beam pairs.

In some cases, a respective UE antenna panel identifier (ID) may also be attached to each TCI state indicated by the UE 504 to the wireless node 502. For example, in some cases, the UE 504 may transmit, to the wireless node 502, an indication of a respective antenna panel ID of an antenna panel, of the one or more antenna panels of the UE 504, associated with each TCI state of the one or more TCI states. For example, in some cases, the UE 504 may indicate that a first antenna panel is associated with a first set of TCI states and may indicate that a second antenna panel is associated with a second set of TCI states.

In some cases, when the persistent drop in signal quality associated with the at least one antenna panel is detected, UE can feedback or indicate the antenna panel ID of the at least one antenna panel associated with persistent drop in signal quality. For example, in some cases, when the persistent drop in signal quality is detected, the information including the indication of the persistent drop in signal quality associated with the at least one antenna panel transmitted by the UE 504 at 510 may further indicate the respective antenna panel ID for the at least one antenna panel.

In some cases, all the associated TCI states corresponding to this antenna panel ID can be deprioritized or provided a lower weight in a scheduling algorithm at the wireless node 502 used to schedule communications between the wireless node 502 and the UE 504. For example, in some cases, taking the one or more actions at 512 by the wireless node 502 may include, based on the persistent drop in signal quality associated with the at least one antenna and the indicated respective antenna panel ID for the at least one antenna panel, transmitting configuration information to the UE 504 deactivating TCI states, of the one or more TCI states indicated by the UE 504, associated with the at least one antenna panel. Accordingly, in some cases, with a single panel ID indication (e.g., which has a low signaling overhead), the UE 504 may be able to influence how the wireless node 502 schedules beams (e.g., for CSI-RS or SRS transmissions).

### Example Operations

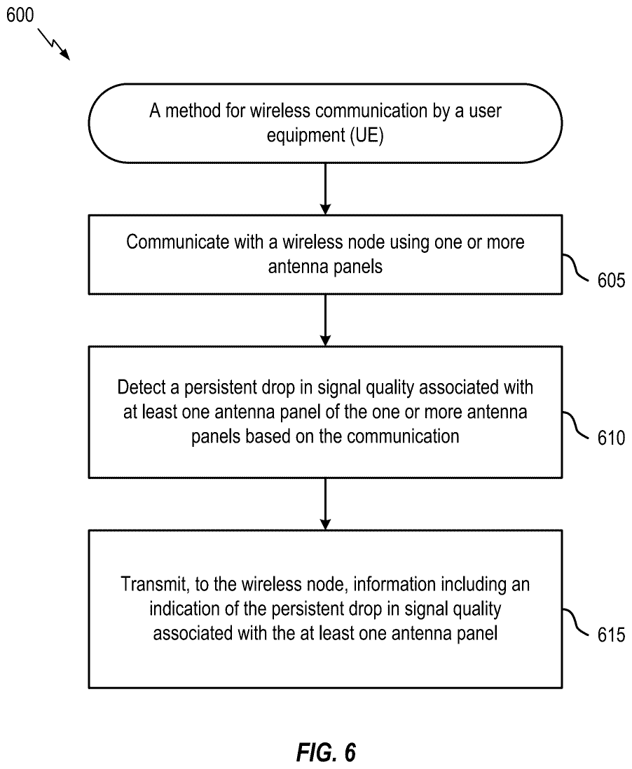

FIG. 6 shows an example of a method 600 of wireless communication by a user equipment (UE), such as a UE 104 of FIGS. 1 and 3.

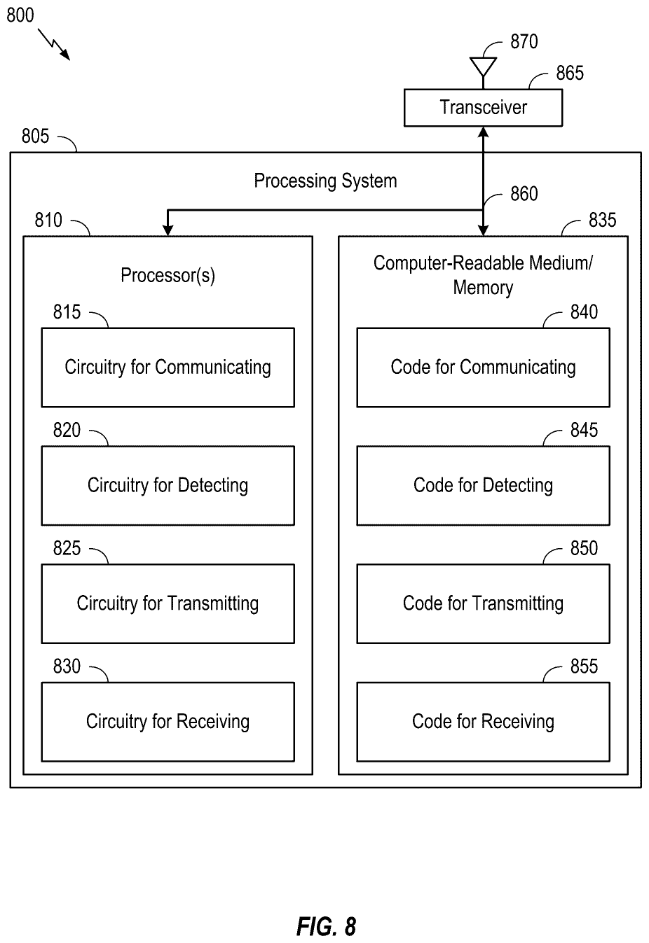

Method 600 begins at step 605 with communicating with a wireless node using one or more antenna panels. In some cases, the operations of this step refer to, or may be performed by, circuitry for communicating and/or code for communicating as described with reference to FIG. 8.

Method 600 then proceeds to step 610 with detecting a persistent drop in signal quality associated with at least one antenna panel of the one or more antenna panels based on the communication. In some cases, the operations of this step refer to, or may be performed by, circuitry for detecting and/or code for detecting as described with reference to FIG. 8.

Method 600 then proceeds to step 615 with transmitting, to the wireless node, information including an indication of the persistent drop in signal quality associated with the at least one antenna panel. In some cases, the operations of this step refer to, or may be performed by, circuitry for transmitting and/or code for transmitting as described with reference to FIG. 8.

In some aspects, the indication of the persistent drop in signal quality comprises at least one of: a persistent decrease in downlink reference signal received power (RSRP) associated with downlink reception using the at least one antenna panel; or a persistent decrease in equivalent isotropic radiated power (EIRP) associated with uplink transmission using the at least one antenna panel.

In some aspects, the information further includes an indication of a restriction related to a rank indicator (RI) for communications between the UE and the wireless node.

In some aspects, the indication of the restriction related to the RI comprises an indication of at least one subset of RIs supported by the UE after the detected persistent drop in signal quality associated with the at least one antenna panel relative to a larger set of RIs supported by the UE prior to the detected persistent drop in signal quality associated with the at least one antenna panel.

In some aspects, the at least one subset of RIs comprises at least one of: a first subset of RIs for downlink signaling; or a second subset of RIs for uplink signaling.

In some aspects, the information further includes an indication of a restriction related to channel quality indicator (CQI) for communications between the UE and the wireless node.

In some aspects, the indication of the restriction related to the CQI comprises an indication of at least one subset of CQIs supported by the UE after the detected persistent drop in signal quality associated with the at least one antenna panel relative to a larger set of CQIs supported by the UE prior to the detected persistent drop in signal quality associated with the at least one antenna panel.

In some aspects, the at least one subset of RIs comprises at least one of: a first subset of CQIs for downlink signaling; or a second subset of CQIs for uplink signaling.

In some aspects, communicating with a wireless node using one or more antenna panels comprises communicating with the wireless node based on a first rank indicator (RI) and a first channel quality indicator (CQI).

In some aspects, the method 600 further includes receiving, from the wireless node based on the indication of the persistent drop in signal quality associated with the at least one antenna panel, configuration information including an indication of at least one of: a second RI that is lower than the first RI a second CQI that is lower than the first CQI. In some cases, the operations of this step refer to, or may be performed by, circuitry for receiving and/or code for receiving as described with reference to FIG. 8.

In some aspects, the information further includes an indication of one or more beams of the wireless node to not use for communicating with the UE.

In some aspects, the persistent drop in the signal quality associated with the at least one antenna panel is based on a malfunction of the at least one antenna panel; and the indication of the one or more beams of the wireless node to not use comprises an indication of an expected performance loss of the one or more beams due to the malfunction of the at least one antenna panel.

In some aspects, communicating with the wireless node comprises communicating with the wireless node using one or more beam pairs associated with the one or more antenna panels.

In some aspects, the method 600 further includes transmitting, to the wireless node, an indication of: one or more transmission configuration indicator (TCI) states associated with the one or more beam pairs reference signal received power (RSRP) measurements associated with the one or more beam pairs. In some cases, the operations of this step refer to, or may be performed by, circuitry for transmitting and/or code for transmitting as described with reference to FIG. 8.

In some aspects, the method 600 further includes transmitting, to the wireless node, an indication of a respective antenna panel identifier (ID) of an antenna panel, of the one or more antenna panels, associated with each TCI state of the one or more TCI states. In some cases, the operations of this step refer to, or may be performed by, circuitry for transmitting and/or code for transmitting as described with reference to FIG. 8.

In some aspects, the information including the indication of the persistent drop in signal quality associated with the at least one antenna panel further indicates the respective antenna panel ID for the at least one antenna panel.

In some aspects, the method 600 further includes receiving, based on the persistent drop in signal quality associated with the at least one antenna panel and the indicated respective antenna panel ID for the at least one antenna panel, configuration information from the wireless node deactivating TCI states, of the one or more TCI states, associated with the at least one antenna panel. In some cases, the operations of this step refer to, or may be performed by, circuitry for receiving and/or code for receiving as described with reference to FIG. 8.

In some aspects, the wireless node comprises one of a network entity or another UE.

In one aspect, method 600, or any aspect related to it, may be performed by an apparatus, such as communications device 800 of FIG. 8, which includes various components operable, configured, or adapted to perform the method 600. Communications device 800 is described below in further detail.

Note that FIG. 6 is just one example of a method, and other methods including fewer, additional, or alternative steps are possible consistent with this disclosure.

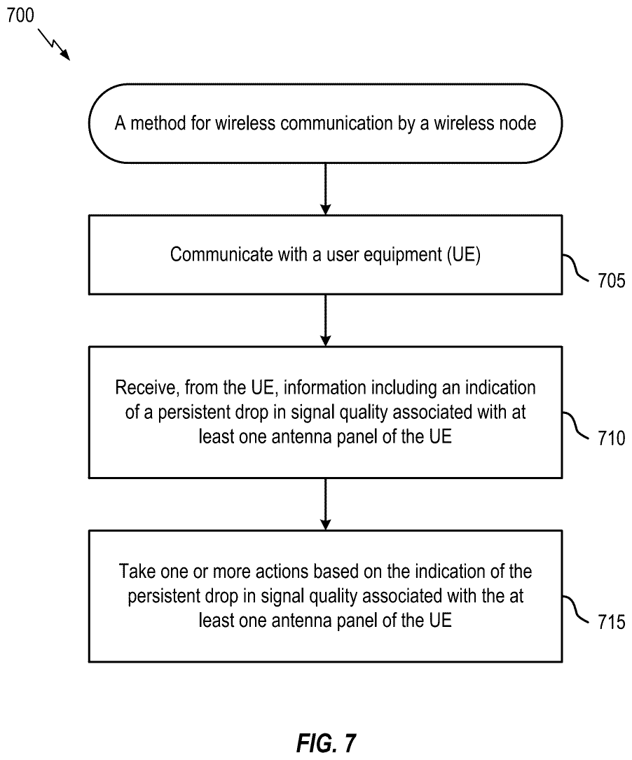

FIG. 7 shows an example of a method 700 of wireless communication by a wireless node. In some examples, the wireless node is a user equipment, such as a UE 104 of FIGS. 1 and 3. In some examples, the wireless node is a network entity, such as a BS 102 of FIGS. 1 and 3, or a disaggregated base station as discussed with respect to FIG. 2.

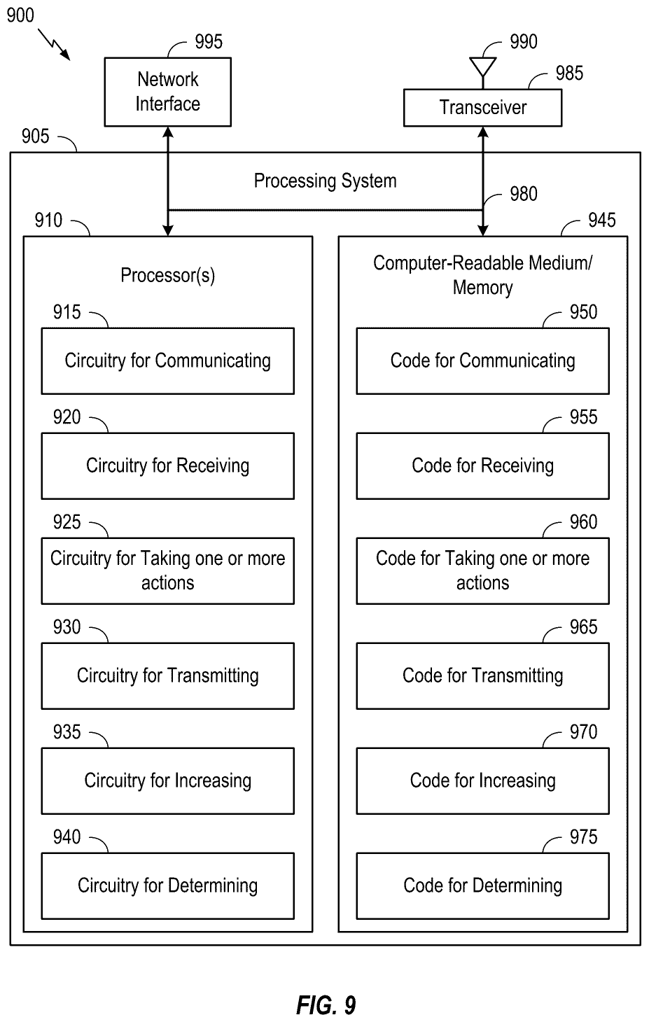

Method 700 begins at step 705 with communicating with a user equipment (UE). In some cases, the operations of this step refer to, or may be performed by, circuitry for communicating and/or code for communicating as described with reference to FIG. 9.

Method 700 then proceeds to step 710 with receiving, from the UE, information including an indication of a persistent drop in signal quality associated with at least one antenna panel of the UE. In some cases, the operations of this step refer to, or may be performed by, circuitry for receiving and/or code for receiving as described with reference to FIG. 9.

Method 700 then proceeds to step 715 with taking one or more actions based on the indication of the persistent drop in signal quality associated with the at least one antenna panel of the UE. In some cases, the operations of this step refer to, or may be performed by, circuitry for taking one or more actions and/or code for taking one or more actions as described with reference to FIG. 9.

In some aspects, the indication of the persistent drop in signal quality comprises at least one of: a persistent decrease in downlink reference signal received power (RSRP) associated with downlink reception using the at least one antenna panel; or a persistent decrease in equivalent isotropic radiated power (EIRP) associated with uplink transmission using the at least one antenna panel.

In some aspects, the information further includes an indication of a restriction related to a rank indicator (RI) for communication between the UE and the wireless node.

In some aspects, the indication of the restriction related to the RI comprises an indication of at least one subset of RIs supported by the UE after the detected persistent drop in signal quality associated with the at least one antenna panel relative to a larger set of RIs supported by the UE prior to the detected persistent drop in signal quality associated with the at least one antenna panel.

In some aspects, the at least one subset of RIs comprises at least one of: a first subset of RIs for downlink signaling; or a second subset of RIs for uplink signaling.

In some aspects, the information further includes an indication of a restriction related to channel quality indicator (CQI) for communication between the UE and the wireless node.

In some aspects, the indication of the restriction related to the CQI comprises an indication of at least one subset of CQIs supported by the UE after the detected persistent drop in signal quality associated with the at least one antenna panel relative to a larger set of CQIs supported by the UE prior to the detected persistent drop in signal quality associated with the at least one antenna panel.

In some aspects, the at least one subset of RIs comprises at least one of: a first subset of CQIs for downlink signaling; or a second subset of CQIs for uplink signaling.

In some aspects, communicating with the UE comprises communicating with the UE based on a first rank indicator (RI) and a first channel quality indicator (CQI).

In some aspects, taking the one or more actions comprises transmitting, to the UE based on the indication of the persistent drop in signal quality associated with the at least one antenna panel, configuration information including an indication of at least one of: a second RI that is lower than the first RI; or a second CQI that is lower than the first CQI.

In some aspects, taking the one or more actions comprises increasing a number of antennas for the communication with the UE.

In some aspects, communicating with the UE comprises communicating with the UE using a plurality of beams; and the information further includes an indication of one or more beams, of the plurality of beams, to not use for communicating with the UE.

In some aspects, the persistent drop in the signal quality associated with the at least one antenna panel is based on a malfunction of the at least one antenna panel; and the indication of the one or more beams of the wireless node to not use comprises an indication of an expected performance loss of the one or more beams due to the malfunction of the at least one antenna panel.

In some aspects, taking the one or more actions comprises determining whether or not to use the one or more beams for communicating with the UE.

In some aspects, the determination is based on channel conditions between the wireless node and the UE.

In some aspects, the determining whether or not to use the one or more beams for communicating with the UE comprises determining to use the one or more beams for communicating with the UE regardless of the expected performance loss of the one or more beams when the channel conditions are below a threshold.

In some aspects, the determining whether or not to use the one or more beams for communicating with the UE comprises: determining to not use the one or more beams for communicating with the UE when the channel conditions are greater than or equal to a threshold; and selecting, from the plurality of beams, one or more other beams for communicating with the UE.

In some aspects, communicating with the UE comprises communicating using one or more beam pairs associated with one or more antenna panels of the UE.

In some aspects, the method 700 further includes receiving, from the UE, an indication of: one or more transmission configuration indicator (TCI) states associated with the one or more beam pairs reference signal received power (RSRP) measurements associated with the one or more beam pairs. In some cases, the operations of this step refer to, or may be performed by, circuitry for receiving and/or code for receiving as described with reference to FIG. 9.

In some aspects, the method 700 further includes receiving, from the UE, an indication of a respective antenna panel identifier (ID) of an antenna panel, of the one or more antenna panels of the UE, associated with each TCI state of the one or more TCI states. In some cases, the operations of this step refer to, or may be performed by, circuitry for receiving and/or code for receiving as described with reference to FIG. 9.

In some aspects, the information including the indication of the persistent drop in signal quality associated with the at least one antenna panel further indicates the respective antenna panel ID for the at least one antenna panel.

In some aspects, taking the one or more actions comprises, based on the persistent drop in signal quality associated with the at least one antenna and the indicated respective antenna panel ID for the at least one antenna panel, transmitting configuration information to the UE deactivating TCI states, of the one or more TCI states, associated with the at least one antenna panel.

In some aspects, the wireless node comprises one of a network entity or another UE.

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Communications Device(s)

FIG. 8 depicts aspects of an example communications device 800. In some aspects, communications device 800 is a user equipment, such as UE 104 described above with respect to FIGS. 1 and 3.

The communications device 800 includes a processing system 805 coupled to the transceiver 865 (e.g., a transmitter and/or a receiver). The transceiver 865 is configured to transmit and receive signals for the communications device 800 via the antenna 870, such as the various signals as described herein. The processing system 805 may be configured to perform processing functions for the communications device 800, including processing signals received and/or to be transmitted by the communications device 800.

The processing system 805 includes one or more processors 810. In various aspects, the one or more processors 810 may be representative of one or more of receive processor 358, transmit processor 364, TX MIMO processor 366, and/or controller/processor 380, as described with respect to FIG. 3. The one or more processors 810 are coupled to a computer-readable medium/memory 835 via a bus 860. In certain aspects, the computer-readable medium/memory 835 is configured to store instructions (e.g., computer-executable code) that when executed by the one or more processors 810, cause the one or more processors 810 to perform the method 600 described with respect to FIG. 6, or any aspect related to it. Note that reference to a processor performing a function of communications device 800 may include one or more processors 810 performing that function of communications device 800.

In the depicted example, computer-readable medium/memory 835 stores code (e.g., executable instructions), such as code for communicating 840, code for detecting 845, code for transmitting 850, and code for receiving 855. Processing of the code for communicating 840, code for detecting 845, code for transmitting 850, and code for receiving 855 may cause the communications device 800 to perform the method 600 described with respect to FIG. 6, or any aspect related to it.

The one or more processors 810 include circuitry configured to implement (e.g., execute) the code stored in the computer-readable medium/memory 835, including circuitry such as circuitry for communicating 815, circuitry for detecting 820, circuitry for transmitting 825, and circuitry for receiving 830. Processing with circuitry for communicating 815, circuitry for detecting 820, circuitry for transmitting 825, and circuitry for receiving 830 may cause the communications device 800 to perform the method 600 described with respect to FIG. 6, or any aspect related to it.

Various components of the communications device 800 may provide means for performing the method 600 described with respect to FIG. 6, or any aspect related to it. For example, means for transmitting, sending or outputting for transmission may include transceivers 354 and/or antenna(s) 352 of the UE 104 illustrated in FIG. 3 and/or the transceiver 865 and the antenna 870 of the communications device 800 in FIG. 8. Means for receiving or obtaining may include transceivers 354 and/or antenna(s) 352 of the UE 104 illustrated in FIG. 3 and/or the transceiver 865 and the antenna 870 of the communications device 800 in FIG. 8.

FIG. 9 depicts aspects of an example communications device 900. In some aspects, communications device 900 is a user equipment, such as UE 104 described above with respect to FIGS. 1 and 3. In some aspects, communications device 900 is a network entity, such as BS 102 of FIGS. 1 and 3, or a disaggregated base station as discussed with respect to FIG. 2.

The communications device 900 includes a processing system 905 coupled to the transceiver 985 (e.g., a transmitter and/or a receiver). In some aspects (e.g., when communications device 900 is a network entity), processing system 905 may be coupled to a network interface 995 that is configured to obtain and send signals for the communications device 900 via communication link(s), such as a backhaul link, midhaul link, and/or fronthaul link as described herein, such as with respect to FIG. 2. The transceiver 985 is configured to transmit and receive signals for the communications device 900 via the antenna 990, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. In various aspects, one or more processors 910 may be representative of one or more of receive processor 338, transmit processor 320, TX MIMO processor 330, and/or controller/processor 340, as described with respect to FIG. 3. The one or more processors 910 are coupled to a computer-readable medium/memory 945 via a bus 980. In certain aspects, the computer-readable medium/memory 945 is configured to store instructions (e.g., computer-executable code) that when executed by the one or more processors 910, cause the one or more processors 910 to perform the method 700 described with respect to FIG. 7, or any aspect related to it. Note that reference to a processor performing a function of communications device 900 may include one or more processors 910 performing that function of communications device 900.

In the depicted example, computer-readable medium/memory 945 stores code (e.g., executable instructions), such as code for communicating 950, code for receiving 955, code for taking one or more actions 960, code for transmitting 965, code for increasing 970, and code for determining 975. Processing of the code for communicating 950, code for receiving 955, code for taking one or more actions 960, code for transmitting 965, code for increasing 970, and code for determining 975 may cause the communications device 900 to perform the method 700 described with respect to FIG. 7, or any aspect related to it.

The one or more processors 910 include circuitry configured to implement (e.g., execute) the code stored in the computer-readable medium/memory 945, including circuitry for communicating 915, circuitry for receiving 920, circuitry for taking one or more actions 925, circuitry for transmitting 930, circuitry for increasing 935, and circuitry for determining 940. Processing with circuitry for communicating 915, circuitry for receiving 920, circuitry for taking one or more actions 925, circuitry for transmitting 930, circuitry for increasing 935, and circuitry for determining 940 may cause the communications device 900 to perform the method 700 described with respect to FIG. 7, or any aspect related to it.

Various components of the communications device 900 may provide means for performing the method 700 described with respect to FIG. 7, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 985 and the antenna 990 of the communications device 900 in FIG. 9. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 985 and the antenna 990 of the communications device 900 in FIG. 9.

### Example Clauses

Implementation examples are described in the following numbered clauses:

Clause 1: A method for wireless communication by a user equipment (UE), comprising: communicating with a wireless node using one or more antenna panels; detecting a persistent drop in signal quality associated with at least one antenna panel of the one or more antenna panels based on the communication; and transmitting, to the wireless node, information including an indication of the persistent drop in signal quality associated with the at least one antenna panel.

Clause 2: The method of Clause 1, wherein the indication of the persistent drop in signal quality comprises at least one of: a persistent decrease in downlink reference signal received power (RSRP) associated with downlink reception using the at least one antenna panel; or a persistent decrease in equivalent isotropic radiated power (EIRP) associated with uplink transmission using the at least one antenna panel.

Clause 3: The method of any one of Clauses 1-2, wherein the information further includes an indication of a restriction related to a rank indicator (RI) for communications between the UE and the wireless node.

Clause 4: The method of Clause 3, wherein the indication of the restriction related to the RI comprises an indication of at least one subset of RIs supported by the UE after the detected persistent drop in signal quality associated with the at least one antenna panel relative to a larger set of RIs supported by the UE prior to the detected persistent drop in signal quality associated with the at least one antenna panel.

Clause 5: The method of Clause 3, wherein the at least one subset of RIs comprises at least one of: a first subset of RIs for downlink signaling; or a second subset of RIs for uplink signaling.

Clause 6: The method of any one of Clauses 1-5, wherein the information further includes an indication of a restriction related to channel quality indicator (CQI) for communications between the UE and the wireless node.

Clause 7: The method of Clause 6, wherein the indication of the restriction related to the CQI comprises an indication of at least one subset of CQIs supported by the UE after the detected persistent drop in signal quality associated with the at least one antenna panel relative to a larger set of CQIs supported by the UE prior to the detected persistent drop in signal quality associated with the at least one antenna panel.

Clause 8: The method of Clause 6, wherein the at least one subset of RIs comprises at least one of: a first subset of CQIs for downlink signaling; or a second subset of CQIs for uplink signaling.

Clause 9: The method of any one of Clauses 1-8, wherein communicating with a wireless node using one or more antenna panels comprises communicating with the wireless node based on a first rank indicator (RI) and a first channel quality indicator (CQI).

Clause 10: The method of Clause 9, further comprising receiving, from the wireless node based on the indication of the persistent drop in signal quality associated with the at least one antenna panel, configuration information including an indication of at least one of: a second RI that is lower than the first RI a second CQI that is lower than the first CQI.

Clause 11: The method of any one of Clauses 1-10, wherein the information further includes an indication of one or more beams of the wireless node to not use for communicating with the UE.

Clause 12: The method of Clause 11, wherein: the persistent drop in the signal quality associated with the at least one antenna panel is based on a malfunction of the at least one antenna panel; and the indication of the one or more beams of the wireless node to not use comprises an indication of an expected performance loss of the one or more beams due to the malfunction of the at least one antenna panel.

Clause 13: The method of any one of Clauses 1-12, wherein communicating with the wireless node comprises communicating with the wireless node using one or more beam pairs associated with the one or more antenna panels.

Clause 14: The method of Clause 13, further comprising transmitting, to the wireless node, an indication of: one or more transmission configuration indicator (TCI) states associated with the one or more beam pairs reference signal received power (RSRP) measurements associated with the one or more beam pairs.

Clause 15: The method of Clause 14, further comprising transmitting, to the wireless node, an indication of a respective antenna panel identifier (ID) of an antenna panel, of the one or more antenna panels, associated with each TCI state of the one or more TCI states.

Clause 16: The method of Clause 15, wherein the information including the indication of the persistent drop in signal quality associated with the at least one antenna panel further indicates the respective antenna panel ID for the at least one antenna panel.

Clause 17: The method of Clause 16, further comprising receiving, based on the persistent drop in signal quality associated with the at least one antenna panel and the indicated respective antenna panel ID for the at least one antenna panel, configuration information from the wireless node deactivating TCI states, of the one or more TCI states, associated with the at least one antenna panel.

Clause 18: The method of any one of Clauses 1-17, wherein the wireless node comprises one of a network entity or another UE.

Clause 19: A method for wireless communication by a wireless node, comprising: communicating with a user equipment (UE); receiving, from the UE, information including an indication of a persistent drop in signal quality associated with at least one antenna panel of the UE; and taking one or more actions based on the indication of the persistent drop in signal quality associated with the at least one antenna panel of the UE.

Clause 20: The method of Clause 19, wherein the indication of the persistent drop in signal quality comprises at least one of: a persistent decrease in downlink reference signal received power (RSRP) associated with downlink reception using the at least one antenna panel; or a persistent decrease in equivalent isotropic radiated power (EIRP) associated with uplink transmission using the at least one antenna panel.

Clause 21: The method of any one of Clauses 19-20, wherein the information further includes an indication of a restriction related to a rank indicator (RI) for communication between the UE and the wireless node.

Clause 22: The method of Clause 21, wherein the indication of the restriction related to the RI comprises an indication of at least one subset of RIs supported by the UE after the detected persistent drop in signal quality associated with the at least one antenna panel relative to a larger set of RIs supported by the UE prior to the detected persistent drop in signal quality associated with the at least one antenna panel.

Clause 23: The method of Clause 21, wherein the at least one subset of RIs comprises at least one of: a first subset of RIs for downlink signaling; or a second subset of RIs for uplink signaling.

Clause 24: The method of any one of Clauses 19-23, wherein the information further includes an indication of a restriction related to channel quality indicator (CQI) for communication between the UE and the wireless node.

Clause 25: The method of Clause 24, wherein the indication of the restriction related to the CQI comprises an indication of at least one subset of CQIs supported by the UE after the detected persistent drop in signal quality associated with the at least one antenna panel relative to a larger set of CQIs supported by the UE prior to the detected persistent drop in signal quality associated with the at least one antenna panel.

Clause 26: The method of Clause 24, wherein the at least one subset of RIs comprises at least one of: a first subset of CQIs for downlink signaling; or a second subset of CQIs for uplink signaling.

Clause 27: The method of any one of Clauses 19-26, wherein communicating with the UE comprises communicating with the UE based on a first rank indicator (RI) and a first channel quality indicator (CQI).

Clause 28: The method of Clause 27, wherein taking the one or more actions comprises transmitting, to the UE based on the indication of the persistent drop in signal quality associated with the at least one antenna panel, configuration information including an indication of at least one of: a second RI that is lower than the first RI; or a second CQI that is lower than the first CQI.

Clause 29: The method of any one of Clauses 19-28, wherein taking the one or more actions comprises increasing a number of antennas for the communication with the UE.

Clause 30: The method of any one of Clauses 19-29, wherein: communicating with the UE comprises communicating with the UE using a plurality of beams; and the information further includes an indication of one or more beams, of the plurality of beams, to not use for communicating with the UE.

Clause 31: The method of Clause 30, wherein: the persistent drop in the signal quality associated with the at least one antenna panel is based on a malfunction of the at least one antenna panel; and the indication of the one or more beams of the wireless node to not use comprises an indication of an expected performance loss of the one or more beams due to the malfunction of the at least one antenna panel.

Clause 32: The method of Clause 31, wherein taking the one or more actions comprises determining whether or not to use the one or more beams for communicating with the UE.

Clause 33: The method of Clause 32, wherein the determination is based on channel conditions between the wireless node and the UE.

Clause 34: The method of Clause 33, wherein the determining whether or not to use the one or more beams for communicating with the UE comprises determining to use the one or more beams for communicating with the UE regardless of the expected performance loss of the one or more beams when the channel conditions are below a threshold.

Clause 35: The method of Clause 33, wherein the determining whether or not to use the one or more beams for communicating with the UE comprises: determining to not use the one or more beams for communicating with the UEE when the channel conditions are greater than or equal to a threshold; and selecting, from the plurality of beams, one or more other beams for communicating with the UE.

Clause 36: The method of any one of Clauses 19-35, wherein communicating with the UE comprises communicating using one or more beam pairs associated with one or more antenna panels of the UE.

Clause 37: The method of Clause 36, further comprising receiving, from the UE, an indication of: one or more transmission configuration indicator (TCI) states associated with the one or more beam pairs reference signal received power (RSRP) measurements associated with the one or more beam pairs.

Clause 38: The method of Clause 37, further comprising receiving, from the UE, an indication of a respective antenna panel identifier (ID) of an antenna panel, of the one or more antenna panels of the UE, associated with each TCI state of the one or more TCI states.

Clause 39: The method of Clause 38, wherein the information including the indication of the persistent drop in signal quality associated with the at least one antenna panel further indicates the respective antenna panel ID for the at least one antenna panel.

Clause 40: The method of Clause 39, wherein taking the one or more actions comprises, based on the persistent drop in signal quality associated with the at least one antenna and the indicated respective antenna panel ID for the at least one antenna panel, transmitting configuration information to the UE deactivating TCI states, of the one or more TCI states, associated with the at least one antenna panel.

Clause 41: The method of any one of Clauses 19-40, wherein the wireless node comprises one of a network entity or another UE.

Clause 42: An apparatus, comprising: at least one memory comprising executable instructions; and at least one processor configured to execute the executable instructions and cause the apparatus to perform a method in accordance with any combination of Clauses 1-41.

Clause 43: An apparatus, comprising means for performing a method in accordance with any combination of Clauses 1-41.

Clause 44: A non-transitory computer-readable medium comprising executable instructions that, when executed by at least one processor of an apparatus, cause the apparatus to perform a method in accordance with any combination of Clauses 1-41.

Clause 45: A computer program product embodied on a computer-readable storage medium comprising code for performing a method in accordance with any combination of Clauses 1-41.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S. C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE), comprising:
one or more processors individually or collectively configured to execute instructions stored on one or more memories and to cause the UE to:
communicate with a wireless node using one or more antenna panels;
detect a persistent drop in signal quality associated with at least one antenna panel of the one or more antenna panels based on the communication; and
transmit, to the wireless node, information including an indication of the persistent drop in signal quality associated with the at least one antenna panel.

2. The UE of claim 1, wherein the indication of the persistent drop in signal quality comprises at least one of:
a persistent decrease in downlink reference signal received power (RSRP) associated with downlink reception using the at least one antenna panel; or
a persistent decrease in equivalent isotropic radiated power (EIRP) associated with uplink transmission using the at least one antenna panel.

3. The UE of claim 1, wherein the information further includes an indication of a restriction related to a rank indicator (RI) for communications between the UE and the wireless node.

4. The UE of claim 3, wherein the indication of the restriction related to the RI comprises an indication of at least one subset of RIs supported by the UE after the detected persistent drop in signal quality associated with the at least one antenna panel relative to a larger set of RIs supported by the UE prior to the detected persistent drop in signal quality associated with the at least one antenna panel.

5. The UE of claim 4, wherein the at least one subset of RIs comprises at least one of:
a first subset of RIs for downlink signaling; or
a second subset of RIs for uplink signaling.

6. The UE of claim 1, wherein the information further includes an indication of a restriction related to channel quality indicator (CQI) for communications between the UE and the wireless node.

7. The UE of claim 6, wherein the indication of the restriction related to the CQI comprises an indication of at least one subset of CQIs supported by the UE after the detected persistent drop in signal quality associated with the at least one antenna panel relative to a larger set of CQIs supported by the UE prior to the detected persistent drop in signal quality associated with the at least one antenna panel.

8. The UE of claim 7, wherein the at least one subset of RIs comprises at least one of:
a first subset of CQIs for downlink signaling; or
a second subset of CQIs for uplink signaling.

9. The UE of claim 1, wherein the one or more processors are configured to cause the UE to with the wireless node based on a first rank indicator (RI) and a first channel quality indicator (CQI).

10. The UE of claim 9, wherein the one or more processors are further configured to cause the UE to receive, from the wireless node based on the indication of the persistent drop in signal quality associated with the at least one antenna panel, configuration information including an indication of at least one of:
a second RI that is lower than the first RI; or
a second CQI that is lower than the first CQI.

11. The UE of claim 1, wherein the information further includes an indication of one or more beams of the wireless node to not use for communicating with the UE.

12. The UE of claim 11, wherein:
the persistent drop in the signal quality associated with the at least one antenna panel is based on a malfunction of the at least one antenna panel; and
the indication of the one or more beams of the wireless node to not use comprises an indication of an expected performance loss of the one or more beams due to the malfunction of the at least one antenna panel.

13. The UE of claim 1, wherein the one or more processors are configured to cause the UE to communicate with the wireless node using one or more beam pairs associated with the one or more antenna panels.

14. The UE of claim 13, wherein the one or more processors are further configured to cause the UE to transmit, to the wireless node, an indication of:
one or more transmission configuration indicator (TCI) states associated with the one or more beam pairs; and
reference signal received power (RSRP) measurements associated with the one or more beam pairs.

15. The UE of claim 14, wherein the one or more processors are further configured to cause the UE to transmit, to the wireless node, an indication of a respective antenna panel identifier (ID) of an antenna panel, of the one or more antenna panels, associated with each TCI state of the one or more TCI states.

16. The UE of claim 15, wherein the information including the indication of the persistent drop in signal quality associated with the at least one antenna panel further indicates the respective antenna panel ID for the at least one antenna panel.

17. The UE of claim 16, wherein the one or more processors are further configured to cause the UE to receive, based on the persistent drop in signal quality associated with the at least one antenna panel and the indicated respective antenna panel ID for the at least one antenna panel, configuration information from the wireless node deactivating TCI states, of the one or more TCI states, associated with the at least one antenna panel.

18. The UE of claim 1, wherein the wireless node comprises one of a network entity or another UE.

19. A method for wireless communication by user equipment (UE), comprising:
communicating with a wireless node using one or more antenna panels;
detecting a persistent drop in signal quality associated with at least one antenna panel of the one or more antenna panels based on the communication; and
transmitting, to the wireless node, information including an indication of the persistent drop in signal quality associated with the at least one antenna panel.

20. A wireless node, comprising:
one or more processors individually or collectively configured to execute instructions stored on one or more memories and to cause the wireless node to:
communicate with a user equipment (UE);
receive, from the UE, information including an indication of a persistent drop in signal quality associated with at least one antenna panel of the UE; and
take one or more actions based on the indication of the persistent drop in signal quality associated with the at least one antenna panel of the UE.
